(19) United States
(12) Patent Application Publication
(10) Pub. No.: US 2007/0148697 A1
(43) Pub. Date: Jun. 28, 2007

(54) Methods and system for high throughput screening of polymer materials for medical devices

(75) Inventors: Joseph T. Delaney JR., Minneapolis, MN (US); Thomas G. Gardner, Andover, MN (US)

Correspondence Address: MAYER & WILLIAMS PC, 251 NORTH AVENUE WEST, 2ND FLOOR, WESTFIELD, NJ, 07090, US

(73) Assignee: Boston Scientific Scimed, Inc.

(21) Appl. No.: 11/318,692

(22) Filed: Dec. 27, 2005

(51) Int. Cl. C40B 30/02; C40B 40/04; C40B 40/10

(52) U.S. Cl. 435/7.1; 436/518; 702/19

(57) ABSTRACT

The present invention provides a system for high-throughout analysis of a polymeric formulation for implantable and insertable medical devices comprising a plurality of dots arranged to form an array on a substrate having at least an x axis and y axis, each dot comprising a polymeric composition and wherein a gradient exists in at least one of the x axis or y axis for at least one pre-selected parameter, and the array is analyzed using at least one analytical technique at least at two time points, T₀ and T₁ to generate data at these time points for the pre-selected parameter.

### FIELD OF THE INVENTION

The present invention relates to the characterization of materials used in the field of medical devices. In particular, the invention relates to high-throughput screening methods of polymer materials that may be used as a component of insertable or implantable medical devices, such as balloon catheters, stents and other similar diagnostic or therapeutic devices, which may be provided within the body for treatment and diagnosis of diseases and conditions.

### BACKGROUND OF THE INVENTION

Numerous medical devices have been developed for the delivery of therapeutic agents to the body. The desired release profile for the therapeutic agent is dependent upon the particular treatment at hand, including the specific condition being treated or prevented, the specific site of administration, the specific therapeutic agent selected, and so forth.

Materials which are suitable for use in making implantable or insertable medical devices typically exhibit one or more of the qualities of exceptional biocompatibility, lubricity/tacticity, wettability, bioerosion/biostability, extrudability, elasticity, moldability, good fiber forming properties, tensile strength, durability, and the like. Moreover, the physical and chemical characteristics of the device materials can play an important role in determining other properties, including shelf life stability, or release rate of the therapeutic agent.

In accordance with some typical delivery strategies, a therapeutic agent is provided within a polymeric carrier layer and/or beneath a polymeric barrier layer that is associated with a medical device. Once the medical device is placed at the desired location within a patient, the therapeutic agent is released from the medical device at a rate that is dependent upon the nature of the polymeric carrier and/or barrier layer.

It is a continuing challenge to identify optimized polymeric formulation candidates efficiently and cost-effectively. Conventional screening of polymeric coating formulations for biological and/or medical applications typically involves the sequential preparation of a batch of a formulation of interest, then application in a prototype device, physical and chemical analysis of the individual units, and finally evaluation of the performance. Preparing a particular polymer formulation requires considerable resources, offers considerable opportunities for experimental variability, and is ultimately inefficient in comparison to parallel techniques. The exploratory preparation of prototype coating samples with varying formulations is very intensive in terms of both time and resources allocation. In addition, the use of multiple instruments in manufacturing and analyzing test samples introduces greater variability into the discovery process. While many test method variables may be accounted for by using statistically sufficient large number of samples, the amount of time spent analyzing samples and evaluating the results increases accordingly, adding to the overall cost and time spent studying a given set of materials. The result of using such a strategy is that only a small number of formulations may be practically studied at any given time. The prospect of mapping out the relationship between material performance and material formulation in detail is prohibitively expensive. Using such a serial approach, formulation optimization, as well as detailing critical formulation parameters, is costly at best, and impractical at worst.

Furthermore, if a particular time-dependent phenomenon is to be examined, such as bioerosion, kinetic drug release, chemical or mechanical durability, the use of destructive techniques to collect data at specific time points increases the amount of samples required. Essentially, in order to perform any study involving commonly used destructive analytical techniques (e.g., chromatogrpahy, calorimetry, or mass spectroscopy), a separate set of samples is required for each time-point, adding to the overall cost of research, as well as the amount of time required to perform the experiment. In such a scheme, deriving relationships between variations of composition and processing techniques with mechanical and chemical measurements is labor intensive and difficult at best.

A useful working example of this issue is research into drug-loaded coatings for dip- or spray-coated coronary stents. To prepare a particular coating formulation, then apply it to a batch of stents using standard manufacturing equipment, then analyze the coatings kinetic drug release properties by liquid chromatography is a laborious, expensive process with considerable opportunities for variability. The study of new coatings additives, much less formulation optimization and outlining critical formulation parameters for attaining optimal performance, is almost prohibitively expensive using this current approach. Understanding and quantifying the synergistic effects of multiple components and processing conditions on a wide array of material properties would be a great advance in coatings development, but using traditional methodologies, the number of samples required to examine those effects is not practical. To date, the development and optimization of multi-component coatings containing multiple kinetic drug release modifiers, chemical stabilizers, plasticizers, and other performance enhancers has been stymied by this issue.

Various high-throughput technologies are under investigation for the screening of polymeric materials and characterization of mechanical properties of polymer materials. One such high-throughput technology involves combinatorial polymer chemistry involving micro-arrays, i.e., an array of dots on a substrate surface. For example, inkjet printing is being utilized as a tool for synthesizing large numbers of chemically different polymers in parallel. See de Gans, et al., “Inkjet Printing of Polymer Micro-Arrays and Libraries: Instrumentation, Requirements, and Perspectives,” Macromol. Rapid. Commun., 24:659-666 (2003), hereby incorporated by reference in its entirety.

One group has applied high-throughput screening to transdermal drug formulations to study the effect of multiple chemical enhancers on drug delivery. Karande et al., “High throughput screening of transdermal formulations,” Pharmaceutical Research, 19(5):655-660 (2002). While the experimental approach was a considerable advance in the way in which drug release formulations could be developed, other important aspects such as mechanical properties and chemical stability were not studied. Also, the individual samples in the study were prepared by dispensing the individual components manually, rather than using an automated technique; this offers greater opportunity for operator variability, and would limit the number of samples that could be prepared significantly.

Recently, the use of inkjet printing technology in combinatorial materials research has gained greater interest. See Lemmo et al., “Characterization of an Inkjet Chemical Microdispense for Combinatorial Library Synthesis,” Anal. Chem. 69:543-551 (1997); Mohebi et al., “A Drop-on-Demand Ink-jet Printer for Combinatorial Libraries and Functionally Graded Ceramics,” J. Comb. Chem., 4:267-274 (2002); de Gans et al., Macromol. Rapid Commun., 24:659-666 (2003); de Gans et al., Macromol. Rapid Commun., 25:292-296 (2004), all of which are hereby incorporated by reference in their entirety. This approach includes a wide array of different technologies that involve the formation and direction of small (nanoliter scale) droplets to a specific location with high accuracy. See Wallace et al., “Ink-Jet Methods in Combinatorial Materials Synthesis,” in High Throughput Analysis: A Tool for Combinatorial Materials Science (2003) (Kluwer Academic/Plenum Publishers).

In the area of drug delivery, ink-jet technology has been used to create three- dimensional polymer microspheres for localized delivery of anticancer drugs. See Radulescu et al., “3D Printing of Biological Materials for Drug Delivery and Tissue Engineering Applications,” Proc., IS&T's DF05, the International Conference on Digital Fabrication Technologies (2005).

Ink-jet technology has also been used as an alternative to conventional spraying methods to deliver a drug payload to a stent coating. For example, one group has loaded polymer-coated vascular stents with a drug on the outer stent surface using continuous jetting off-axis to the rotating stent. See Tarcha et al., “Drug Loading of Stents with Ink-Jet Technology,” Proc., BioInterface '04 (October, 2004).

Some other efforts to date include the following and they are hereby incorporated by reference in their entirety:

The tensile modulus of a thin polystyrene film having a continuous thickness gradient was calculated by inducing strain-induced buckling instability that produces a modulus dependent wavelength that is measured by optical microscopy, small angle light scattering (SALS) and atomic force microscopy (AFM). Stafford et al., “Combinatorial and high-throughput measurements of the modulus of thin polymer films,” Review of Scientific Instruments, 76:062207 (2005); Stafford et al., “Measuring Modulus of Gradient Polymer Films by Strain-Induced Buckling Instabilities,” Polymer Preprints, 43(2): 1335 (2002).

Crosby et al., “Combinatorial Investigations of Interfacial Failure,” Journal of Polymer Science: Part B: Polymer Physics, 41:883-891 (2003) discloses interfacial strength studies using two-dimensional arrays of spherical microlens of poly(dimethylsiloxane) and polystyrene wherein two adhesion-controlling parameters vary along orthogonal axes and the experiment combinatorially maps the dependence of adhesion on these two parameters in a single test and characterization using optical microscopy.

Vogel et al., “Parallel Synthesis and High Throughput Dissolution Testing of Biodegradable Polyanhydride Copolymers,” J. Comb. Chem., ASAP Article 10.1021/cc050077p S1520-4766(05)00077-5 (web published on Sep. 8, 2005), which is hereby incorporated by reference in its entirety, discloses the synthesis of 100 polyanhydride random copolymers as candidates for controlled drug delivery in microwell array and characterization including FTIR spectrophotometer.

Chiche et al., “A new design for high-throughput peel tests: statistical analysis and example,” Meas. Sci. Technol., 16:183-190 (2005) (first published on Dec. 16, 2004), disclose a method for conducting peel tests of combinatorial specimens. Potyrailo et al., “Role of high-throughput characterization tools in combinatorial material science,” Meas. Sci. Technol., 16:1-4 (2005) (first published Dec. 16, 2004) discusses the challenges of high-throughput characterization of combinatorial materials and recent measurement instrument developed for this purpose.

For a review of recent efforts in high-throughput combinatorial materials screening and characterization, see, for example, the publications by the National Institute of Standards and Technology (NIST)—Polymers Division, in particular publications by three groups within the Polymers Division: Characterization and Measurement Group (http://polymers.msel.nist.gov/researcharea/characterization/index.html); Multivariant Measurement Methods Group (http://polymers.msel.nist.gov/researcharea/combi/index.html); and Biomaterials Group (http://polymers.msel.nist.gov/researcharea/biomaterials/index.html). Three articles titled “High-throughput Method for Determining Young's Modulus of Polymer Blends,” “High-throughput Probe Tack Test,” “High-throughput and combinatorial methods for measuring the mechanical properties of dental materials,” (undated; downloaded from web on May 1, 2005) are hereby incorporated by reference in their entirety.

Despite the recent advances noted above, there is a continuing need for methods and devices for high-throughput screening and testing of materials for drug delivery systems, particularly for systems that are robust and suitable for parallel, non-destructive evaluation using a multitude of characterization techniques. In addition, there is still a need for systems and methods for high-throughput simulations of polymer composites that structurally and/or chemically mimic medical devices such as polymer coated stents and allow for the prediction of the action of the device under in vivo conditions.

### SUMMARY OF THE INVENTION

These and other challenges of the prior art are addressed by the present invention which provides multiple non-destructive high-throughput screening methods for the testing of components and materials for implantable or insertable medical devices and also provides for miniaturized simulated devices for testing the release of a therapeutic agent(s) from insertable or implantable medical devices, such as balloon catheters, stents and other similar diagnostic or therapeutic devices, which may be provided within the body for treatment and diagnosis of diseases and conditions.

The invention also provides a method for high-throughout analysis of a coating composition for implantable and insertable medical devices comprising: forming an array of a plurality of dots comprising a polymeric composition by ink-jet deposition on a substrate having at least an x axis and y axis, varying at least one compositional or mechanical characteristic for the polymeric composition from dot to dot such that a gradient exists in at least one of the x axis or y axis for the pre-selected parameter, and analyzing the array using at least two analytical techniques at least at two time points, T₀ and T₁ to generate data at these time points for the pre-selected parameter.

Rather than preparing separate full batches of polymer-coated products for analysis, many of the same objectives can be achieved by preparing a small dot of coating on a standardized surface. The dot can then be analyzed using non-destructive techniques, subjected to various time-related or time-independent conditions of interest, and the same dot can be retested using a variety of characterization methods and analytical techniques. By preparing an array of dots of different formulations in the same manner on the same substrate in the same run, the issue of lot-to-lot variability in sample preparation is minimized. Likewise, formulation arrays allow for all samples will be exposed to identical conditions for identical lengths of time, which greatly limits testing variability. In this way, the performance of different formulations can be compared most directly.

The present invention is advantageous in that the methods provide the ability to test numerous design and material parameters affecting the construction of a medical device in a non-destructive, repeatable and/or parallel manner. One or more design or composition variables may be tested simultaneously and efficiently. Also, the use of non-destructive tests allows for the same sample to be tested at multiple timepoints, ensuring that changes seen in an individual formulation are accounted for by physical and chemical differences taking place in the system, and not changes in sample preparation.

Another advantage of the present invention is that high-throughput miniaturized versions of an implantable or insertable medical device can be provided to simulate its behavior under in vivo conditions.

Another advantage of the present invention is that combinations of parameters in the design and construction of medical devices can be tested to identify relationships between two or more parameters.

Yet another advantage of the present invention is that it provides a method for high-throughout screening of coatings for implantable or insertable medical devices that have a desirable chemical kinetics profile for a particular therapeutic agent or combination of therapeutic agents.

These and other embodiments and advantages of the present invention will become immediately apparent to those of ordinary skill in the art upon review of the Detailed Description and Claims to follow.

### BRIEF DESCRIPTION OF THE DRAWINGS

FIG. 1A is a schematic representation of an array of deposited coatings on a substrate with gradients in the X- and Y-axis for two components A and B (e.g., therapeutic drug, a component of a copolymer, or coating additive) prepared using ink-jet printing technology. FIG. 1B is a photograph of an actual array constructed according to the schematic representation of FIG. 1A.

### DESCRIPTION OF THE PREFERRED EMBODIMENTS

The present invention provides a system for high-throughout analysis of a polymeric formulation for implantable and insertable medical devices comprising a plurality of dots arranged to form an array on a substrate having at least an x axis and y axis, each dot comprising a polymeric composition and wherein a gradient exists in at least one of the x axis or y axis for at least one pre-selected parameter, and the array is analyzed using at least one analytical technique at least at two time points, T₀ and T₁, to generate data at these time points for the pre-selected parameter. In some embodiments, the polymeric composition comprises a release region and a therapeutic agent within or adjacent to said release region wherein said release region comprises a copolymer that further comprises (i) a biostable copolymer or (ii) a biodisintegrable copolymer. The release region can comprise a biostable block copolymer comprising polystyrene-polyisobutylene-polystyrene and the therapeutic agent comprises paclitaxel.

In the present invention, dots are arranged to form an array using ink-jet printing selected from the group consisting of drop-on-demand printing and continuous mode printing.

As used herein, “ink-jet printing” refers to processes for dispensing spheres of fluid with diameters anywhere from about 5-1000 μm, and typically about 15-200 μm (2 pl to 5 nl) at rates of about 0-25,000 per second for single drops dispensed using “drop-on-demand,” and up to 1 MHz for continuous droplets. In drop-on-demand ink-jet printing, the fluid is typically maintained at ambient pressure and a transducer is used to create a drop only when needed. The transducer creates a volumetric change in the fluid which creates pressure waves. The pressure waves travel to the orifice, are converted to fluid velocity, which results in a drop being ejected from the orifice. Demand mode ink-jet printing generally produces droplets that are approximately equal in diameter to the orifice diameter of the droplet generator and drops less than 20 μm are currently used in photographic quality printers and drop diameters of up to 120 μm have been generated.

In continuous mode ink-jet printing, pressurized fluid is forced through an orifice, typically 50-80 μm in diameter, to form a liquid jet. While not wishing to be bound by theory, it is believed that surface tension acts to amplify even minute variations in the diameter, causing the jet to break into drops. Application of a frequency disturbance in the appropriate frequency range causes the disturbance to be amplified and drops of repeatable and generally uniform size and velocity is generated at the applied disturbance frequency. The disturbance can be generated by any appropriate means, including but not limited to an electromechanical device such as a piezoelectric transducer or speaker that creates pressure oscillations in the fluid. Drop generation rates for commercially available continuous mode ink-jet systems are usually in the 80-1000 kHz range, with drop sizes as small as about 20 μM and as large as about 1 mm in a continuous system.

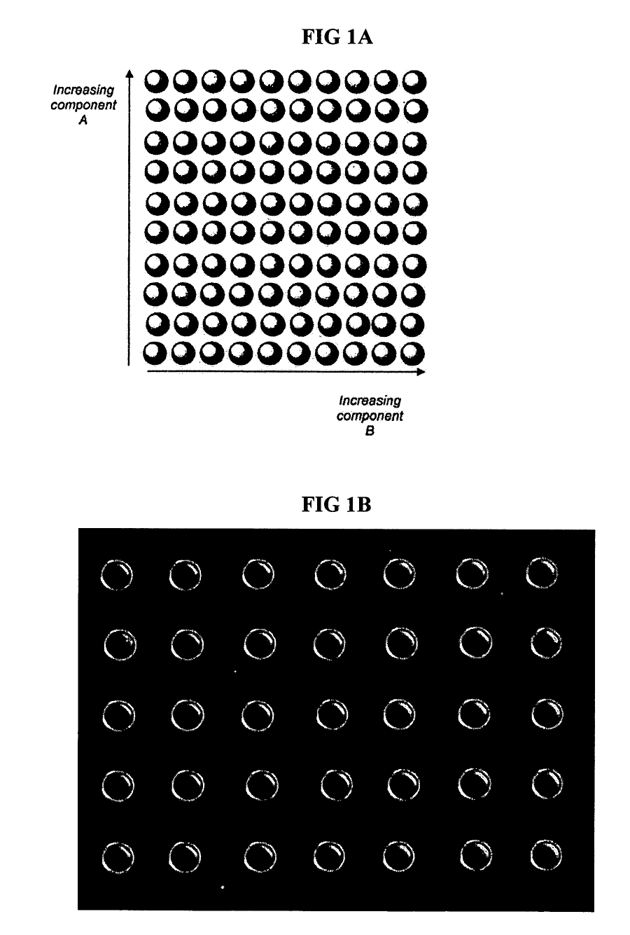

Referring to FIG. 1, library arrays involving one-, two-, and three-dimensionally-programmable spatial variation in composition can be prepared using an inkjet array printer onto a uniform substrate of metal or some other material, then characterized using high-throughput analytical techniques, preferably, non-destructive techniques, including but not limited to UV-Vis spectroscopy, fluorescence microscopy, nanoindentation, scanning probe microscopy comprising atomic force microscopy or chemical force microscopy, field emission electron microscopy, photoacoustic infrared spectroscopy, FTIR- and confocal Raman microscopy, on a motorized stage. In this way, an entire “library” of samples can be prepared efficiently and uniformly, and can be tested repeatedly throughout a run of experiments. The compositional effects on properties such as mechanical/chemical durability, drug release, solubility, biocompatibility, and bioerosion can be evaluated in parallel under identical conditions by exposing the array to the appropriate conditions. In addition, the effects of coating thicknesses and processing conditions such as solvent ratios and adjustments to spray settings can also be investigated and optimized.

Although drop-on-demand printer technology and other “ink-jet”-type technology for deposition of the dots is preferred, any other mode of deposition of an array of discrete compositions of uniform size and which dots vary in at least one parameter is within the scope of the invention. For example, various lithography techniques whereby small aliquots of liquid/fluid medium can be deposited on a test surface with or without a mask may be used in the present invention. For example, spray coating a substrate covered with a stencil having a multitude of openings and then removing the stencil to reveal an array of dots is within the scope of the invention.

The dots of the array can comprise a multitude of components, compounds, and factors, whose effects on a specific parameter such as drug release can be tested in parallel by the array. This results in a multi-dimensional testing system where many factors can be tested in each array and measured through multiple rounds of testing. The different components of the array dot may be formed into a solution and the solvent evaporated to form a discrete dot on the array. In addition to solutions, the dot may comprise any fluid medium, such as polymer melts, dispersions, emulsions, colloids, slurries, suspensions, supercritical fluids, etc. In addition, the various components of the dots may be applied sequentially to create a laminate structure. For example, a drug releasing layer, a barrier layer, an additive layer, and a radiopaque layer may be layered on a substrate comprising a standardized surface such that each dot comprises a multi-layered structure wherein different drugs/agents can be released in a controlled manner.

By using drop-on-demand printer technology, dots or films of coatings of different compositions may be prepared simply by adjusting the different feeds to the nozzle. By spacing the depositions apart in an orderly fashion, thousands of coating samples with progressively variant compositions can be prepared on a single substrate by simply delivering different amounts of different solutions to different parts of the substrate. In this way, an entire library of coatings of different compositions and processing conditions can be prepared on a single metal surface in an ordered fashion.

The advantages to such a system are numerous. Data-mining techniques can be used to elucidate relationships between different variables quickly and efficiently, enabling optimization with minimal effort. The small size of the samples means far fewer demands on resources, and the automated sample preparation eliminates operator variability within a given materials library. The use of non-destructive analytical techniques allows the same samples to be tested multiple times to measure their progress during time-dependent studies, removing any sample-to-sample comparison ambiguity encountered with approached using destructive analytical techniques. Also, since all coatings on a single materials library would be subjected to identical conditions, this ensures more reliability when comparing the performance of different formulations.

By examining both chemical and mechanical properties, the relationship between chemical composition and physical performance can be examined more closely, so that material parameters can be established to minimize issues such as embrittlement, surface tackiness, chemical/thermal instability, homogeneity, and other properties that may affect performance adversely. In this way, the same samples can be used to study the effects of different formulations in an efficient, multidisciplinary, information-rich manner.

In some embodiments, the polymer composition of the array dots comprises a diblock copolymer having constituent blocks A and B, wherein the array is subjected to a solvent and the pre-selected parameter comprises molar composition of A and B and each dot of the array comprises a different composition of constituents A and B to form a molar gradient in the x-axis of the array.

In this regard, the invention comprises a system for creating an array of a candidate polymer composition (array comprises a plurality of test points, each point with slightly different composition such as an AB copolymer where the ratio of A to B (mol %) is altered to create a concentration gradient across the array). The materials and methods for producing inkjet printed arrays of polymer compounds are known to one of skill in the art. Exemplary protocols are provided in de Gans et al., Macromol. Rapid Commun., 24:659-666 (2003); de Gans et al., Macromol. Rapid Commun., 25:292-296 (2004). Once formed, the array is subjected to a host of environmental, chemical and mechanical testing and data is recorded at different time points, e.g., T₀, T₁, Tₓ, and T_{final}.

For example, in one test, AB copolymer of varying molar compositions are applied to a array such that each dot consists of a different composition of constituents A and B of the AB copolymer in the X-axis of the array. Similarly, rather than a copolymer, the polymer composition can be a copolymer with one or more homopolymers or a blend of two or more polymers. A therapeutic agent may additionally be added to the dots to create a concentration gradient of the therapeutic agent with respect to the y-axis of the array.

In some embodiments, the polymer composition comprises a therapeutic agent, wherein a second pre-selected parameter comprises the concentration of therapeutic agent and each dot of the array comprises a different concentration of the therapeutic agent to form a concentration gradient in the y-axis of the array. After time point T₁, the array is removed from the solvent and the concentration of therapeutic agent remaining on the dots is measured using at least one analytical technique comprising scanning probe microscopy comprising atomic force microscopy, field emission electron microscopy, FTIR microscopy, confocal Raman microscopy, and photoacoustic infrared spectroscopy such that a profile of the release of the therapeutic agent as a function of time, concentration of therapeutic agent, and molar composition of A and B block polymers is produced. The array may be subjected to subsequent steps of placement in a solvent, mechanical testing comprising testing of tack, elastic modulus, elongation modulus, glass transition temperature, nano-indentation, surface topography or at least one analytical technique to obtain additional data at time points Tₓ, and T_{final}, wherein x is a whole number greater than 1.

The array is then subjected to any one of a number of nondestructive characterization methods, such as Raman spectroscopy and infrared spectroscopy to determine the concentration of the general compound, the copolymer and/or drug at T₀. Mechanical testing such as nano-indentation (e.g., pressure applied to measure elastic modulus, for example) can be performed on the individual dots to measure and record each Theological parameter such as tack, elastic modulus, elongation modulus, glass transition temperatures, etc. at T₀. The array can be used to test a host of other parameters, including chemical composition and surface topography. Subsequently, the effects can then be correlated to kinetic drug release characteristics, bioerodibility of the polymer, tack, lubricity, solubility, adhesion properties to a substrate, dry release characteristics, thermal stability, stability under different chemical and/or biological conditions, stability during radiation exposure, etc.

While two-dimensional gradient arrays can be produced by varying two different properties, each along a different axis, ternary (three-variant), quaternary (four-variant) and even higher dimensional systems are within the scope of the invention. Edge-sharing techniques (wherein two adjacent array “dots” share at least one common edge or perimeter) may also be utilized to increase the number of possibilities in efficient library design.

In some embodiments, the polymer composition of the array dots comprises a biostable polymer having a release region and a therapeutic agent, wherein the array is placed in a solvent and the concentration of therapeutic agent at time T₁, is measured using non-destructive methods comprising Raman or infrared spectroscopy, wherein spectroscopy peaks are measured against a standard to quantify release of therapeutic agent from the polymer.

When using biostable polymers, the amount of drug remaining after treatment in a drug releasing medium (e.g., any suitable fluid medium in which release of the therapeutic agent from the dots can be measured), is determined using Raman or infrared spectroscopy. The spectroscopy peaks can be measured against a standard to show how much drug is left. In some embodiments, the polymer composition for the microarray dots comprises a biodisintegrable polymer, wherein the array is subjected to a solvent and the concentration of therapeutic agent at time T₁, is measured using non-destructive methods comprising Raman or infrared spectroscopy, wherein the release of therapeutic agent from the polymer is quantified by correlating an increase in signal attenuation to disintegration of the polymer. When using biodisintegrable/bioerodable polymer-drug systems, the drug remaining in the polymer composition can be measured by the level of signal attenuation that occurs as the drug-filled polymer is eroded.

In one example, the array comprises a plurality of dots with various polymer/drug compositions is subjected to a drug release media. After a period of time, T₁, the array is removed from the media and the concentration of drug/polymer remaining on the respective dots is measured using a variety of characterization methods such as the microscopy/spectroscopy methods discussed above. The concentration of drug/polymer remaining on the respective dots provides a profile of the drug release characteristics as a function of time, polymer composition, and drug concentration. The effect of the material composition of the dot on the drug release characteristics may then be determined as well as the effect of the composition of polymer on the drug release characteristics. The effect on the mechanical properties can also be determined by subjecting the array to mechanical testing at T₁. The array can then be subjected to subsequent rounds of immersion into a drug release media and mechanical testing to obtain multiple data points for each dot over a period of time. Since the dot is not destroyed by the preferred analytical characterization methods, the effects of various parameters on a specific dot having a particular composition can be tested to measure the cumulative effects over time.

A preferred embodiment is a system comprising of a model drug and copolymer. For example, the effects of varying a system consisting of poly(styrene-co-isobutylene-co-styrene) (“SIBS”) and a paclitaxel analog (e.g., taxol-C) are examined. In studying this system, one variable is the amount of taxol-C. Another variable is the mole percent of polystyrene in the SIBS polymer. Also, SIBS and taxol-C is combined in different concentrations. If two different batches of SIBS with two different mole percent styrene values are combined in different amounts, a SIBS-based material of essentially any mole percent styrene in between can be obtained. By combining solutions of them in different amounts that add up to approximately the same total weight (e.g., 150 ng), a series of dots of materials with similar dimensions (e.g., about 10 μm height by about 100 μm diameter) can be prepared, ensuring comparable mechanical properties.

In another embodiment, the invention comprises a simulation of a medical device where each dot on the array simulates a medical device (e.g., a coated stent) having certain compositions and characteristics. For example, a drug-eluting metal stent can be simulated by preparing an array wherein each dot comprises a metal substrate layer with an overlying polymer layer having a therapeutic agent. For example, a micromachined stainless steel slide can serve as the simulated metallic stent. On top of the metal slide, an array of dots of varying compositions can be placed. The thickness of the metal overlying polymer layer can be controlled so that it mimics the thickness of the actual stent in the body. The array is then subjected to a variety of environmental conditions that it would encounter either in the body (e.g., exposure to a variety of blood borne or other in vivo factors and conditions), during manufacturing (e.g., sterilization involving EtO or radiation during manufacturing), and/or kinetic drug release tests, mechanical tests, or other tests. Each dot of the array serves as a miniaturized version of the device component, and allows for the evaluation of material performance, enabling formulation optimization of the actual device.

The data collected by taking measurements of the dots of the array (at least one or more dots comprising a subset of the array) at various time points is used to select a subset of candidates suitable for a particular application. By identifying the formulation candidates offering the best performance for each given criteria, e.g. drug release profile, elasticity, and durability, one may narrow the number to those where these properties overlap most desirably.

The present invention provides miniaturized simulations of an implantable or insertable medical device can be provided to simulate its behavior under in vivo conditions wherein the simulations comprise individual dots on an array wherein at least one parameter is variable among the individual dots.

Thus, in another aspect of the invention, the present invention provides an array of simulations of an implantable or insertable medical device having a drug release coating wherein the array is formed of a plurality of dots arranged on a substrate layer having at least an x axis and y axis, each dot comprising a polymeric composition comprising at least one polymer layer comprising a release region wherein a therapeutic agent is within or adjacent to release region, wherein a gradient exists in at least one of the x axis or y axis for at least one pre-selected parameter, and the array is analyzed using at least one analytical technique at least at two time points, T₀ and T₁ to generate data at these time points for the pre-selected parameter. In preferred embodiments, the dots are arranged to form an array using ink-jet printing selected from the group consisting of drop-on-demand printing and continuous mode printing.

The array can have at least one additive layer comprising one or more of drug release modifiers, chemical stabilizers, leveling agents, plasticizers, elastomeric additives, whetting agents, slip agents, therapeutic agents, lubricants, cross-linking agents, free radical initiators, free radical scavengers, antioxidants, colorants, radioopacifiers, stiffening agents, nucleating agents, and swelling agents.

As was the case for the systems described above, a gradient may exist in at least one of the x axis or y axis for at least one pre-selected parameter such that when the array is analyzed using at least one analytical technique for at least at two time points, T₀ and T₁, data is generated at these time points for a pre-selected parameter.

In some embodiments, each dot comprises a simulation of a drug-eluting stent wherein the dot comprises a substrate, a polymer coating comprising carrier regions and barrier regions, and a therapeutic agent. In addition to (or in lieu of), therapeutic agents, the system of the present invention may be used to test the effects of other ingredients or additives (“auxiliary ingredients”) such as drug release modifiers, radioopacifiers, colorants, binders, blending agents, stiffening agents, wetting agents, oxidants, antioxidants, plasticizers, nucleating agents, adherent agents, lubricating agents, chemical stabilizers, leveling agents, cross-linking agents, elastomeric additives, slip agents, free radical initiators, free radical scavengers, swelling agents, etc.

In addition, the various components of the dots may be applied sequentially to create a laminate structure. For example, a drug releasing layer, a barrier layer, an additive layer, and a radiopaque layer may be layered on a substrate comprising a standardized surface such that each dot comprises a multi-layered structure wherein different drugs/agents can be released in a controlled manner.

Preferably, the substrate is made of the same materials as an implantable or insertable medical device, such as a stent, to which a release region/layer would be applied. For example, the substrate for a stent or implantable or insertable medical device may comprise, stainless steel, titanium, tantalum, gold, platinum, gold-plated stainless steel, cobalt-chromium alloys including but not limited to cobalt-chromium-nickel-molybdenum-iron alloys, shape-memory alloys including but not limited to nickel-titanium (Ni—Ti) and Ni—Ti-based alloys, Ni—Ti covered with polytetrafluoroethylenes (PTFE) (for example, SYMBIOT® stent, manufactured by Boston Scientific Corp., Natick, Mass.), carbon-fiber composites, nanotubes, clay nanoparticles, polymers including silicone, plastics (including but not limited to polyethylenes and polyurethanes), ceramics, natural polymers comprising biologically-occurring polymers including Type I collagen, and biodisintegrable polymers comprising polyesters, polyorthoesters, and polyanhydrides including but not limited to poly(ether-ester)s, L,L-dilactide, diglycolid, and p-dioxanone. A review of various stent materials is provided in Lim, “Biocompatibility of Stent Materials,” MIT Undergraduate Research Journal, 11:33-37 (2004).

Each simulated medical device may further comprise a polymer coating comprising a release region. Preferably, ink-jet printing technology is used to build layers of a simulated medical device such as the stent substrate layer, a polymer coating layer and a therapeutic drug layer. For example, a mixture containing solvent, polymer and supplemental polymer, if any, and other materials are applied to a substrate to form a release region. Where appropriate, ink-jet printing may be repeated or combined to build up a release layer to a desired thickness. Typically, ink-jet printing involves a solvent-based technique, and thus, after application to the substrate, the individual dots are preferably dried after application to remove the solvents. The release region typically further conforms to any underlying surface during the drying process.

Other polymeric materials can serve as the coating that contains release regions in the simulated medical devices. In particular, it is generally desired to use polymers that provide one or more characteristics of biocompatibility, biostability, and physical and chemical properties of known polymers such as SIBS and provide enhanced drug release characteristics from the release region.

Polymers for use in accordance with the simulated devices and systems and methods of the present invention can be selected from a wide range of polymers, which may be, for example, linear or branched, natural or synthetic, or crosslinked or uncrosslinked. The selected polymers are preferably processable using solvent-based processing techniques suitable for ink-jet printing, lithography, or other method of dispensing discrete micro-aliquots of polymer. Appropriate polymers can be selected from the following, among others: polycarboxylic acid polymers and copolymers including polyacrylic acids (e.g., acrylic latex dispersions and various polyacrylic acid products such as HYDROPLUS, available from Boston Scientific Corporation, Natick Mass. and described in U.S. Pat. No. 5,091,205, the disclosure of which is hereby incorporated herein by reference, and HYDROPASS, also available from Boston Scientific Corporation); acetal polymers and copolymers; acrylate and methacrylate polymers and copolymers; cellulosic polymers and copolymers, including cellulose acetates, cellulose nitrates, cellulose propionates, cellulose acetate butyrates, cellophanes, rayons, rayon triacetates, and cellulose ethers such as carboxymethyl celluloses and hydroxyalkyl celluloses; maleic anhydride polymers and copolymers; polyoxymethylene polymers and copolymers; polyimide polymers and copolymers such as polyether block imides, polyamidimides, polyesterimides, and polyetherimides; polysulfone polymers and copolymers including polyarylsulfones and polyethersulfones; polyamide polymers and copolymers including nylon-6,6, nylon-11, nylon-12, polycaprolactams and polyacrylamides; resins including alkyd resins, phenolic resins, urea resins, melamine resins, epoxy resins, allyl resins and epoxide resins; polycarbonates; polyacrylonitriles; polyvinylpyrrolidones (cross-linked and otherwise); polymers and copolymers of vinyl monomers including polyvinyl alcohols, polyvinyl halides such as polyvinyl chlorides, ethylene-vinylacetate copolymers (EVA), polyvinylidene chlorides, polyvinyl ethers such as polyvinyl methyl ethers, polystyrenes, styrene-butadiene copolymers, acrylonitrile- styrene copolymers, acrylonitrile-butadiene-styrene copolymers, styrene-butadiene- styrene copolymers and styrene-isobutylene-styrene copolymers, polyvinyl ketones, polyvinylcarbazoles, and polyvinyl esters such as polyvinyl acetates; polybenzimidazoles; ionomers; polyalkyl oxide polymers and copolymers including polyethylene oxides (PEO); glycosaminoglycans; polyesters including polyethylene terephthalates and aliphatic polyesters such as polymers and copolymers of lactide (which includes lactic acid as well as d-, 1- and meso lactide), epsilon-caprolactone, glycolide (including glycolic acid), hydroxybutyrate, hydroxyvalerate, para-dioxanone, trimethylene carbonate (and its alkyl derivatives), 1,4-dioxepan-2-one, 1,5-dioxepan-2-one, and 6,6-dimethyl-1,4-dioxan-2-one (a copolymer of polylactic acid and polycaprolactone is one specific example); polyether polymers and copolymers including polyarylethers such as polyphenylene ethers, polyether ketones, polyether ether ketones; polyphenylene sulfides; polyisocyanates (e.g., U.S. Pat. No. 5,091,205 describes medical devices coated with one or more polyisocyanates such that the devices become instantly lubricious when exposed to body fluids); polyolefin polymers and copolymers, including polyalkylenes such as polypropylenes, polyethylenes (low and high density, low and high molecular weight), polybutylenes (such as polybut-1-ene and polyisobutylene), poly-4-methyl-pen-1-enes, ethylene- alpha-olefin copolymers, ethylene-methyl methacrylate copolymers and ethylene-vinyl acetate copolymers; fluorinated polymers and copolymers, including polytetrafluoroethylenes (PTFE), poly(tetrafluoroethylene-co-hexafluoropropene) (FEP), modified ethylene-tetrafluoroethylene copolymers (ETFE), and polyvinylidene fluorides (PVDF); silicone polymers and copolymers; polyurethanes (e.g., BAYHYDROL polyurethane dispersions); p-xylylene polymers; polyiminocarbonates; copoly(ether-esters)such as polyethylene oxide-polylactic acid copolymers; polyphosphazines; polyalkylene oxalates; polyoxaamides and polyoxaesters (including those containing amines and/or amido groups); polyorthoesters; biopolymers, such as polypeptides, proteins, polysaccharides and fatty acids (and esters thereof), including fibrin, fibrinogen, collagen, elastin, chitosan, gelatin, starch, glycosaminoglycans such as hyaluronic acid; as well as various blends and copolymers of all the above.

Exemplary polymers include block copolymers comprising at least two polymeric blocks A and B. Examples of such block copolymers include the following: (a) BA (linear diblock), (b) BAB or ABA (linear triblock), (c) B(AB)ₙ or A(BA)ₙ (linear alternating block), or (d) X-(AB)ₙ or X-(BA)ₙ (includes diblock, triblock and other radial block copolymers), where n is a positive whole number and X is a starting seed, or initiator, molecule.

Exemplary embodiments also include the use of random and statistical copolymers comprising at least two polymeric repeating units, A and B. Examples of such block copolymers include poly(methacrylate-c-butylacrylate) and poly(methyacrylate-c-octylacrylate).

In some embodiments, polyolefins, which are generally considered biostable, are preferred. For example, the A blocks can be polyolefinic blocks having alternating quaternary and secondary carbons of the general formulation: —(CRR′-CH₂)ₙ—, where R and R′ are linear or branched aliphatic groups such as methyl, ethyl, propyl, isopropyl, butyl, isobutyl and so forth, or cyclic aliphatic groups such as cyclohexane, cyclopentane, and the like, with and without pendant groups. Preferred polyolefinic blocks include blocks of isobutylene, 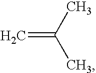
(i.e., polymers where R and R¹ are the same and are methyl groups). A can also be a silicone rubber block, an acrylate rubber block, and so forth.

The B blocks can, for example, comprise hard thermoplastic blocks with glass transition temperatures significantly higher than the elastomeric A block that, when combined with the soft A blocks, are capable of, inter alia, altering or adjusting the hardness of the resulting copolymer to achieve a desired combination of qualities. Preferred B blocks are polymers of methacrylates or polymers of vinyl aromatics.

More preferred B blocks are (a) made from monomers of styrene 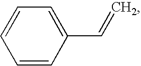
styrene derivatives (e.g., α-methylstyrene, ring-alkylated styrenes or ring-halogenated styrenes) or mixtures of the same (collectively referred to herein as “styrenic blocks” or “polystyrenic blocks”) or are (b) made from monomers of methylmethacrylate, ethylmethacrylate hydroxyethyl methacrylate or mixtures of the same.

In some particularly preferred embodiments of the present invention, the polymer comprises (a) a copolymer of polyisobutylene with polystyrene or polymethylstyrene, more preferably polystyrene-polyisobutylene-polystyrene (SIBS) triblock copolymers that, along with other polymers appropriate for the practice of the present invention, are described, for example, in U.S. Pat. Nos. 5,741,331, 4,946,899 and 6,545,097 to Pinchuk et al., each of which is hereby incorporated by reference in its entirety; (b) arborescent polyisobutylene-polystyrene block copolymers such as those described in Kwon et al., “Arborescent Polyisobutylene-Polystyrene Block Copolymers-a New Class of Thermoplastic Elastomers,” Polymer Preprints, 2002, 43(1), 266, the entire disclosure of which is incorporated by reference, or (c) a copolymer containing one or more blocks of polystyrene and one or more random polymer blocks of ethylene and butylene, for example, a polystyrene-polyethylenelbutylene-polystyrene (SEBS) copolymer, available as Kraton® g G series polymers. An additional preferred polymer is an n-butyl methacrylate (BMA) polymer available from Aldrich Chemical.

As described in Pinchuk et al., supra, the release profile characteristics of therapeutic agents such as paclitaxel from SIBS copolymer systems demonstrate that these copolymers are effective drug delivery systems for providing therapeutic agents to sites in vivo. These copolymers are particularly useful for medical device applications because of their excellent strength, biostability and biocompatibility, particularly within the vasculature. For example, SIBS copolymers exhibit high tensile strength, which frequently ranges from 2,000 to 4,000 psi or more, and resist cracking and other forms of degradation under typical in vivo conditions. Biocompatibility, including vascular compatibility, of these materials has been demonstrated by their tendency to provoke minimal adverse tissue reactions (e.g., as measured by reduced macrophage activity). In addition, these polymers are generally hemocompatible as demonstrated by their ability to minimize thrombotic occlusion of small vessels when applied as a coating on coronary stents. Furthermore, these polymers possess many interesting physical and chemical properties sought after in medical devices, due to the combination of polymer blocks.

The release regions of the simulated medical devices of the present invention optionally include a supplemental polymer in addition to the above-described copolymers. A variety of polymers are available for use as supplemental polymers in the release regions of the present invention. For example, the supplemental polymer may be a homopolymer or a copolymer (including alternating, random, statistical, gradient and block copolymers), may be cyclic, linear or branched (e.g., polymers have star, comb or dendritic architecture), may be natural or synthetic, and may be thermoplastic or thermosetting.

When using biostable polymers, the amount of drug remaining after treatment in a drug releasing medium, can be measured using Raman or infrared spectroscopy. The spectroscopy peaks can be measured against a standard to show how much drug is left. When using bioerodable polymer-drug systems, the drug remaining in the polymer composition can be measured by the level of signal attenuation that occurs as the drug-filled polymer is eroded.

In other embodiments, the polymer coating comprises a biodisintegrable polymer. As used herein, a “biodisintegrable polymer” is a polymer or copolymer that undergoes dissolution, degradation, resorption and/or other disintegration process upon administration to a patient. The disintegration process may involve surface- erosion, bulk erosion or a combination of both. Examples of biodisintegrable polymers include the following: (a) polyesters, for example, polymers and copolymers of hydroxyacids and lactones, such as glycolic acid, lactic acid, tartronic acid, fumaric acid, hydroxybutyric acid, hydroxyvaleric acid, dioxanone, caprolactone and valerolactone, (b) polyanhydrides, for example, polymers and copolymers of various diacids such as sebacic acid and 1,6-bis(p-carboxyphoxy) alkanes, for instance, 1,6-bis(p-carboxyphoxy) hexane and 1,6-bis(p-carboxyphoxy) propane; (c) tyrosine-derived polycarbonates, and (d) polyorthoesters.

Specific examples of biodisintegrable polymers include polyesters such as poly(glycolic acid) blocks, poly(lactic acid) blocks, poly(lactic acid-co-glycolic acid) blocks, and polycaprolactone blocks.

Release regions for use in accordance with the present invention include carrier regions and barrier regions. By “carrier region” is meant a release region which further comprises a therapeutic agent and from which the therapeutic agent is released. For example, in some embodiments, a carrier region is disposed over all or a portion of a medical device substrate. In other embodiments, a carrier region constitutes the entirety of the simulated medical device.

By “barrier region” is meant a region which is disposed between a source of therapeutic agent and a site of intended release, and which controls the rate at which therapeutic agent is released. For example, in some embodiments, the medical device is provided with a barrier region that surrounds a source of therapeutic agent. In other embodiments, a barrier region is disposed over a source of therapeutic agent, which is in turn disposed over all or a portion of a medical device substrate.

Hence, in various embodiments, release regions for use in accordance with the present invention are in the form of a release layers, which cover all or a part of the simulated medical device substrate. As used herein a “layer” of a given material is a region of that material whose thickness is small compared to both its length and width. As used herein a layer need not be planar or conformal (for example, taking on the contours of an underlying substrate). Layers can be discontinuous (e.g., patterned). Terms such as “film,” “layer” and “coating” may be used interchangeably herein.

Where a carrier region is formed (as opposed to, for example, a barrier region), a therapeutic agent can be dissolved or dispersed in the polymer/solvent mixture if desired, and hence co-established with the carrier region. In other embodiments, on the other hand, the therapeutic agent can be dissolved or dispersed within a solvent, and the resulting solution contacted with a polymer region that is previously formed using, for example, one or more of the application techniques described above (e.g., dipping, spraying, etc.).

Barrier layers, on the other hand, are formed over a therapeutic-agent-containing region, for example, using solvent-based techniques such as those discussed above in which the copolymer and supplemental polymer, if any, are first dissolved or dispersed in a solvent, and the resulting mixture is subsequently used to form the barrier layer. The barrier layer serves, for example, as a boundary layer to retard diffusion of the therapeutic agent, for example, acting to prevent a burst phenomenon whereby much of the therapeutic agent is released immediately upon exposure of the device or a portion of the device to the implant or insertion site. Ink-jet technology may be utilized to form the barrier layers.

As would be appreciated by one of skill in the art, the present invention may be used to simulate and create a small-scale and/or simplified version of not only stents, but a variety of medical devices, particularly suitable for implantation or insertion into the body, and even more particularly, to those that comprise a drug delivery system.

As described above, the therapeutic agent may be contained within the carrier region. In other embodiments, the therapeutic agent beneath the barrier layer is established without an associated polymer. In this case, the therapeutic agent can simply be dissolved or dispersed in a solvent or liquid, and using ink-jet or other micro-volume dispensing technology, the resulting solution/dispersion can be contacted with the substrate. In these embodiments, the polymeric composition of the barrier region may, or may not be the same as the polymeric composition of the underlying carrier region containing a therapeutic agent.

As used herein, “medical devices” as referred to with respect to the present invention include essentially any medical device for which controlled release of a therapeutic agent is desired. Examples of medical devices include implantable or insertable medical devices, for example, catheters (e.g., renal or vascular catheters such as balloon catheters), guide wires, balloons, filters (e.g., vena cava filters), stents (including coronary vascular stents, cerebral, urethral, ureteral, biliary, tracheal, gastrointestinal and esophageal stents), stent grafts, cerebral aneurysm filler coils (including Guglilmi detachable coils and metal coils), vascular grafts, myocardial plugs, patches, pacemakers and pacemaker leads, heart valves, biopsy devices, and any coated substrate (which can comprise, for example, glass, metal, polymer, ceramic and combinations thereof) that is implanted or inserted into the body and from which therapeutic agent is released. Examples of medical devices further include patches for delivery of therapeutic agent to intact skin and broken skin (including wounds); sutures, suture anchors, anastomosis clips and rings, tissue staples and ligating clips at surgical sites; orthopedic fixation devices such as interference screws in the ankle, knee, and hand areas, tacks for ligament attachment and meniscal repair, rods and pins for fracture fixation, screws and plates for craniomaxillofacial repair; dental devices such as void fillers following tooth extraction and guided-tissue-regeneration membrane films following periodontal surgery; and tissue engineering scaffolds for cartilage, bone, skin and other in vivo tissue regeneration.

By “medical device” is meant medical devices that are used for either systemic treatment or for the localized treatment of any mammalian tissue or organ. Non-limiting examples are tumors; organs including the heart, coronary and peripheral vascular system (referred to overall as “the vasculature”), lungs, trachea, esophagus, brain, liver, kidney, bladder, urethra and ureters, eye, intestines, stomach, pancreas, vagina, uterus, ovary, and prostate; skeletal muscle; smooth muscle; breast; dermal tissue; cartilage; and bone.

Specific examples of medical devices include vascular stents, which deliver therapeutic agent into the vasculature for the treatment of restenosis. In these embodiments, the release region is typically provided over all or a portion of a stent substrate, and is typically in the form of a carrier layer (in which case therapeutic agent is disposed within the release layer) or a barrier layer (in which case the release layer is disposed over a therapeutic-agent containing region).

As used herein, “treatment” refers to the prevention of a disease or condition, the reduction or elimination of symptoms associated with a disease or condition, or the substantial or complete elimination of a disease or condition. Preferred subjects are mammalian subjects and more preferably human subjects.

“Therapeutic agents”, “pharmaceutically active agents”, “pharmaceutically active materials”, “drugs” and other related terms may be used interchangeably herein and include genetic therapeutic agents, non-genetic therapeutic agents and cells. Therapeutic agents may be used singly or in combination. Therapeutic agents may be, for example, nonionic or they may be anionic and/or cationic in nature.

Exemplary non-genetic therapeutic agents for use in connection with the present invention include: (a) anti-thrombotic agents such as heparin, heparin derivatives, urokinase, and PPack (dextrophenylalanine proline arginine chloromethylketone); (b) anti-inflammatory agents such as dexamethasone, prednisolone, corticosterone, budesonide, estrogen, sulfasalazine and mesalamine; (c) antineoplastic/antiproliferative/anti-miotic agents such as paclitaxel, 5-fluorouracil, cisplatin, vinblastine, vincristine, epothilones, endostatin, angiostatin, angiopeptin, monoclonal antibodies capable of blocking smooth muscle cell proliferation, and thymidine kinase inhibitors; (d) anesthetic agents such as lidocaine, bupivacaine and ropivacaine; (e) anti-coagulants such as D-Phe-Pro-Arg chloromethyl ketone, an RGD peptide-containing compound, heparin, hirudin, antithrombin compounds, platelet receptor antagonists, anti-thrombin antibodies, anti-platelet receptor antibodies, aspirin, prostaglandin inhibitors, platelet inhibitors and tick antiplatelet peptides; (f) vascular cell growth promoters such as growth factors, transcriptional activators, and translational promoters; (g) vascular cell growth inhibitors such as growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and a cytotoxin; (h) protein kinase and tyrosine kinase inhibitors (e.g., tyrphostins, genistein, quinoxalines); (i) prostacyclin analogs; j) cholesterol-lowering agents; (k) angiopoietins; (I) antimicrobial agents such as triclosan, cephalosporins, aminoglycosides and nitrofurantoin; (m) cytotoxic agents, cytostatic agents and cell proliferation affectors; (n) vasodilating agents; (o) agents that interfere with endogenous vasoactive mechanisms; (p) inhibitors of leukocyte recruitment, such as monoclonal antibodies; (q) cytokines; (r) hormones; and (s) inhibitors of HSP 90 protein (i.e., Heat Shock Protein, which is a molecular chaperone or housekeeping protein and is needed for the stability and function of other client proteins/signal transduction proteins responsible for growth and survival of cells) including geldanamycin.

Preferred non-genetic therapeutic agents include paclitaxel, sirolimus, everolimus, tacrolimus, Epo D, dexamethasone, estradiol, halofuginone, cilostazole, geldanamycin, ABT-578 (Abbott Laboratories), trapidil, liprostin, Actinomycin D, Resten-NG, Ap-17, abciximab, clopidogrel and Ridogrel, among others.

Exemplary genetic therapeutic agents for use in connection with the present invention include anti-sense DNA and RNA as well as DNA coding for the various proteins (as well as the proteins themselves): (a) anti-sense RNA, (b) tRNA or rRNA to replace defective or deficient endogenous molecules, (c) angiogenic and other factors including growth factors such as acidic and basic fibroblast growth factors, vascular endothelial growth factor, endothelial mitogenic growth factors, epidermal growth factor, transforming growth factor α and β, platelet-derived endothelial growth factor, platelet-derived growth factor, tumor necrosis factor α, hepatocyte growth factor and insulin-like growth factor, (d) cell cycle inhibitors including CD inhibitors, and (e) thymidine kinase (“TK”) and other agents useful for interfering with cell proliferation. Also of interest is DNA encoding for the family of bone morphogenic proteins (“BMP's”), including BMP-2, BMP-3, BMP-4, BMP-5, BMP-6 (Vgr-1), BMP-7 (OP-1), BMP-8, BMP-9, BMP-10, BMP-11, BMP-12, BMP-13, BMP-14, BMP-15, and BMP-16. Currently preferred BMP's are any of BMP-2, BMP-3, BMP-4, BMP-5, BMP-6 and BMP-7. These dimeric proteins can be provided as homodimers, heterodimers, or combinations thereof, alone or together with other molecules. Alternatively, or in addition, molecules capable of inducing an upstream or downstream effect of a BMP can be provided. Such molecules include any of the “hedgehog” proteins, or the DNA's encoding them.

Vectors for delivery of genetic therapeutic agents include viral vectors such as adenoviruses, gutted adenoviruses, adeno-associated virus, retroviruses, alpha virus (Semliki Forest, Sindbis, etc.), lentiviruses, herpes simplex virus, replication competent viruses (e.g., ONYX-015) and hybrid vectors; and non-viral vectors such as artificial chromosomes and mini-chromosomes, plasmid DNA vectors (e.g., pCOR), cationic polymers (e.g., polyethyleneimine, polyethyleneimine (PEI)), graft copolymers (e.g., polyether-PEI and polyethylene oxide-PEI), neutral polymers such as polyvinylpyrrolidone (PVP), SP1017 (SUPRATEK), lipids such as cationic lipids, liposomes, lipoplexes, nanoparticles, or microparticles, with and without targeting sequences such as the protein transduction domain (PTD).

Cells for use in connection with the present invention include cells of human origin (autologous or allogeneic), including whole bone marrow, bone marrow derived mono-nuclear cells, progenitor cells (e.g., endothelial progenitor cells), stem cells (e.g., mesenchymal, hematopoietic, neuronal), pluripotent stem cells, fibroblasts, myoblasts, satellite cells, pericytes, cardiomyocytes, skeletal myocytes or macrophage, or from an animal, bacterial or fungal source (xenogeneic), which can be genetically engineered, if desired, to deliver proteins of interest.

Numerous therapeutic agents, not necessarily exclusive of those listed above, have been identified as candidates for vascular treatment regimens, for example, as agents targeting restenosis. Such agents are useful for the practice of the present invention and include one or more of the following: (a) Ca-channel blockers including benzothiazapines such as diltiazem and clentiazem, dihydropyridines such as nifedipine, amlodipine and nicardapine, and phenylalkylamines such as verapamil, (b) serotonin pathway modulators including: 5-HT antagonists such as ketanserin and naftidrofuryl, as well as 5-HT uptake inhibitors such as fluoxetine, (c) cyclic nucleotide pathway agents including phosphodiesterase inhibitors such as cilostazole and dipyridamole, adenylate/Guanylate cyclase stimulants such as forskolin, as well as adenosine analogs, (d) catecholamine modulators including a-antagonists such as prazosin and bunazosine, β-antagonists such as propranolol and α/β-antagonists such as labetalol and carvedilol, (e) endothelin receptor antagonists, (f) nitric oxide donors/releasing molecules including organic nitrates/nitrites such as nitroglycerin, isosorbide dinitrate and amyl nitrite, inorganic nitroso compounds such as sodium nitroprusside, sydnonimines such as molsidomine and linsidomine, nonoates such as diazenium diolates and NO adducts of alkanediamines, S-nitroso compounds including low molecular weight compounds (e.g., S-nitroso derivatives of captopril, glutathione and N-acetyl penicillamine) and high molecular weight compounds (e.g., S-nitroso derivatives of proteins, peptides, oligosaccharides, polysaccharides, synthetic polymers/oligomers and natural polymers/oligomers), as well as C-nitroso-compounds, O-nitroso-compounds, N-nitroso-compounds and L-arginine, (g) ACE inhibitors such as cilazapril, fosinopril and enalapril, (h) ATII-receptor antagonists such as saralasin and losartin, (i) platelet adhesion inhibitors such as albumin and polyethylene oxide, j) platelet aggregation inhibitors including cilostazole, aspirin and thienopyridine (ticlopidine, clopidogrel) and GP IIb/IIIa inhibitors such as abciximab, epitifibatide and tirofiban, (k) coagulation pathway modulators including heparinoids such as heparin, low molecular weight heparin, dextran sulfate and β-cyclodextrin tetradecasulfate, thrombin inhibitors such as hirudin, hirulog, PPACK(D-phe-L-propyl-L-arg-chloromethylketone) and argatroban, FXa inhibitors such as antistatin and TAP (tick anticoagulant peptide), Vitamin K inhibitors such as warfarin, as well as activated protein C, (l) cyclooxygenase pathway inhibitors such as aspirin, ibuprofen, flurbiprofen, indomethacin and sulfinpyrazone, (m) natural and synthetic corticosteroids such as dexamethasone, prednisolone, methprednisolone and hydrocortisone, (n) lipoxygenase pathway inhibitors such as nordihydroguairetic acid and caffeic acid, (o) leukotriene receptor antagonists, (p) antagonists of E- and P-selectins, (q) inhibitors of VCAM-1 and ICAM-1 interactions, (r) prostaglandins and analogs thereof including prostaglandins such as PGE1 and PGI2 and prostacyclin analogs such as ciprostene, epoprostenol, carbacyclin, iloprost and beraprost, (s) macrophage activation preventers including bisphosphonates, (t) HMG-CoA reductase inhibitors such as lovastatin, pravastatin, fluvastatin, simvastatin and cerivastatin, (u) fish oils and omega-3-fatty acids, (v) free-radical scavengers/antioxidants such as probucol, vitamins C and E, ebselen, trans-retinoic acid and SOD mimics, (w) agents affecting various growth factors including FGF pathway agents such as bFGF antibodies and chimeric fusion proteins, PDGF receptor antagonists such as trapidil, IGF pathway agents including somatostatin analogs such as angiopeptin and ocreotide, TGF-β pathway agents such as polyanionic agents (heparin, fucoidin), decorin, and TGF-β antibodies, EGF pathway agents such as EGF antibodies, receptor antagonists and chimeric fusion proteins, TNF-α pathway agents such as thalidomide and analogs thereof, Thromboxane A2 (TXA2) pathway modulators such as sulotroban, vapiprost, dazoxiben and ridogrel, as well as protein tyrosine kinase inhibitors such as tyrphostin, genistein and quinoxaline derivatives, (x) MMP pathway inhibitors such as marimastat, ilomastat and metastat, (y) cell motility inhibitors such as cytochalasin B, (z) antiproliferative/antineoplastic agents including antimetabolites such as purine analogs (e.g., 6-mercaptopurine or cladribine, which is a chlorinated purine nucleoside analog), pyrimidine analogs (e.g., cytarabine and 5-fluorouracil) and methotrexate, nitrogen mustards, alkyl sulfonates, ethylenimines, antibiotics (e.g., daunorubicin, doxorubicin), nitrosoureas, cisplatin, agents affecting microtubule dynamics (e.g., vinblastine, vincristine, colchicine, Epo D, paclitaxel and epothilone), caspase activators, proteasome inhibitors, angiogenesis inhibitors (e.g., endostatin, angiostatin and squalamine), rapamycin, cerivastatin, flavopiridol and suramin, (aa) matrix deposition/organization pathway inhibitors such as halofuginone or other quinazolinone derivatives and tranilast, (bb) endothelialization facilitators such as VEGF and RGD peptide, and (cc) blood rheology modulators such as pentoxifylline.

Numerous additional therapeutic agents useful for the practice of the present invention are also disclosed in U.S. Pat. No. 5,733,925 assigned to NeoRx Corporation, the entire disclosure of which is incorporated by reference.

Therapeutic agents also include ablation agents, sufficient amounts of which will result in necrosis (death) of undesirable tissue, such as malignant tissue, prostatic tissue, and so forth. Examples include osmotic-stress-generating agents, for example, salts such as sodium chloride or potassium chloride; organic solvents, particularly those such as ethanol, which are toxic in high concentrations, while being well tolerated at lower concentrations; free-radical generating agents, for example, hydrogen peroxide, potassium peroxide or other agents that can form free radicals in tissue; basic agents such as sodium hydroxide; acidic agents such as acetic acid and formic acid; enzymes such as collagenase, hyaluronidase, pronase, and papain; oxidizing agents, such as sodium hypochlorite, hydrogen peroxide or potassium peroxide; tissue fixing agents, such as formaldehyde, acetaldehyde or glutaraldehyde; and naturally occurring coagulants, such as gengpin.

As would be appreciated by one of skill in the art, a wide range of therapeutic agent loadings can be used for the methods and simulated medical devices of the present invention, with the pharmaceutically effective amount being readily determined by those of ordinary skill in the art and ultimately depending, for example, upon the condition to be treated, the nature of the therapeutic agent itself, the tissue into which the dosage form is introduced, and so forth.

As would be appreciated by one of skill in the art, a variety of characterization methods may be utilized to analyze the library generated by the array. When using biostable polymers, for example, the amount of drug remaining after treatment in a drug releasing medium, can be measured using Raman or infrared spectroscopy. Or scanning probe microscopy, particularly atomic force microscopy (AFM). For example, the spectroscopy peaks can be measured against a standard to show how much drug is left. When using biodisintegrable polymer-drug systems, for example, the drug remaining in the polymer composition can be measured by the level of signal attenuation that occurs as the drug-filled polymer is eroded.

As reported in the background of the invention, various high-throughout methods for characterizing polymer materials are available to evaluate the effects of a polymer composition on various mechanical effects, and these as well as other methods for chemical and mechanical analytical methods are within the scope of this invention. These non-destructive techniques are preferable to prior methods of analyzing a single point of data by using mass spectrometry and other polymer characterization methods that destroy the sample. Since the arrays can be constructed easily using a small amount of materials, duplicate arrays may be prepared so that more conventional, destructive characterization methods such as electron microscopy, gas chromatography, liquid chromatography, calorimetry, and various mass spectroscopy techniques may be used.

Preferably, the materials “library” generated by the array of dots is characterized by automated, non-destructive means, such as scanning probe microscopy, confocal Raman microscopy, FTIR-microscopy, to yield information on the chemical composition and mechanical properties of each of the samples. Using data-mining software, relationships between these results can be correlated. Given the intricacies of stent design, local pharmacology, tissue biology, and rheology, computational models may be utilized in predicting and understanding drug distribution and deposition from drug-eluting stents. For examples, computational methods such as Bayesian Inference computation, importance sampling techniques in Monte Carlo, dynamic Monte Carlo using Markov Chains, may be utilized to optimize the materials for elution of a particular therapeutic agent in a particular stent device. Field emission electron microscopy can provide more information on morphology and surface chemistry, but may be more labor-intensive, making the analysis of large sample arrays less practical.

After such analysis, the coating materials library can then be subjected to further testing conditions such as accelerated aging, standard kinetic drug release conditions, etc., and then tested again afterward, using the same non-destructive techniques. If the conditions of interest are part of a multiple time-point study, such as kinetic drug release or accelerated aging, the same materials library can be tested multiple times; furthermore, multiple identical copies of the array library can be created if periodic destructive analysis is required.

### EXAMPLE 1

### Construction and Characterization of Array

Using a NP 2.0 Nano-Plotter™ dispenser (GeSim, GmbH, GroBerkmannsdorf, Germany) or a comparable apparatus, different aliquots of solutions of each of the two batches of SIBS is combined to yield a variety of SIBS blends with different mole-percent styrene values and different 7-epi-taxol content. If the mole-percent styrene is varied using a set of 16.5 mole % and 31 mole % styrene solutions, varied in approximately 0.72 mole % increments, a series of 21 different mole % SIBS results. If the concentration of 7-epi-taxol is varied from 0.0 through 25.0 w/w % in 1% increments, a series of 26 different w/w % 7-epi-taxol samples results. With 21 different mole % styrene SIBS, and 26 different 7-epi-taxol concentrations, a total of 546 different combinations is possible. Printing this number of samples orthogonally, the entire library would occupy a space of approximately 4.2 mm×5.2 mm, which easily fits on a corner of a single microscope slide.

The samples are then non-destructively characterized by confocal Raman microscopy, scanning probe microscopy, and attenuated total reflectance (ATR) FTIR microscopy. Confocal Raman microscopy is performed using a Thermo-Nicolet Almega™ confocal Raman microscope fitted with a 633 nm laser. ATR FTIR microscopy is performed using a Thermo-Nicolet Nexus Continuμm™ microscope, fitted with a diamond lens objective. Scanning probe microscopy, particularly atomic force microscopy (AFM) is performed using a Veeco/Digital Instruments NanoScope IIIa instrument.

1. A system for high-throughout analysis of a coating composition for implantable and insertable medical devices comprising a plurality of dots arranged to form an array on a substrate having at least an x axis and y axis, each dot comprising a polymeric composition and wherein a gradient exists in at least one of the x axis or y axis for at least one pre-selected parameter, and the array is analyzed using at least one analytical technique at least at two time points, T₀ and T₁ to generate data at these time points for the pre-selected parameter.

2. The system of claim 1, wherein the dots are arranged to form an array using inkjet printing selected from the group consisting of drop-on-demand printing and continuous mode printing.

3. The system of claim 1, wherein the analytical technique comprises scanning probe microscopy comprising atomic force microscopy, field emission electron microscopy, FTIR microscopy, confocal Raman microscopy, and photoacoustic infrared spectroscopy.

4. The system of claim 1, wherein the polymeric composition comprises copolymers, copolymer blends, therapeutic agents, biostable polymers, biodisintegrable polymers, polyolefins, drug release modifiers, chemical stabilizers, leveling agents, plasticizers, elastomeric additives, whetting agents, slip agents, therapeutic agents, lubricants, cross-linking agents, free radical initiators, free radical scavengers, antioxidants, colorants, radioopacifiers, stiffening agents, nucleating agents, and swelling agents.

5. The system of claim 1, wherein the polymeric composition comprises a release region and a therapeutic agent within or adjacent to said release region wherein said release region comprises a copolymer that further comprises (i) a biostable block or (ii) a biodisintegrable polymer block.

6. The system of claim 5, wherein the release region comprises a biostable block copolymer comprising polystyrene-polyisobutylene-polystyrene and the therapeutic agent comprises paclitaxel.

7. The system of claim 1, wherein the substrate comprises stainless steel, titanium, tantalum, gold, platinum, gold-plated stainless steel, cobalt-chromium alloys including but not limited to cobalt-chromium-nickel-molybdenum-iron alloys, shape-memory alloys comprising nickel-titanium (Ni—Ti), Ni—Ti-based alloys, polymer-covered Ni—Ti comprising polytetrafluoroethylenes (PTFE)-covered Ni—Ti, carbon-fiber composites, polymers comprising silicone, plastics comprising polyethylenes or polyurethanes, ceramics, natural polymers comprising biologically-occurring polymers comprising Type I collagen, and biodisintegrable polymers comprising polyesters, polyorthoesters, and polyanhydrides further comprising poly(ether-ester)s, L,L-dilactide, diglycolid, and p-dioxanone.

8. The system of claim 1, wherein the data for at least two of the array dots is analyzed with data-mining software.

9. The system of claim 1, wherein the data for at least two of the array dots is analyzed using a computational algorithm comprising MonteCarlo algorithm, Bayesian Inference computation, and dynamic Monte Carlo using Markov Chains.

10. The system of claim 1, wherein the polymer composition comprises a biostable polymer having a release region and a therapeutic agent, wherein the array is placed in a fluid medium and the concentration of therapeutic agent at time T₁ is measured using non-destructive methods comprising Raman or infrared spectroscopy, wherein spectroscopy peaks are measured against a standard to quantify release of therapeutic agent from the polymer.

11. The system of claim 1, wherein the polymer composition comprises a biodisintegrable polymer, wherein the array is subjected to a fluid medium and the concentration of therapeutic agent at time T₁ is measured using non-destructive methods comprising Raman or infrared spectroscopy, wherein the release of therapeutic agent from the polymer is quantified by correlating an increase in signal attenuation to disintegration of the polymer.

12. The system of claim 1, wherein the polymer composition comprises a diblock copolymer having constituent blocks A and B, wherein the array is subjected to a fluid medium and the pre-selected parameter comprises molar composition of A and B and each dot of the array comprises a different composition of constituents A and B to form a molar gradient in the x-axis of the array.

13. The system of claim 12, wherein the polymer composition further comprises a therapeutic agent, wherein a second pre-selected parameter comprises the concentration of therapeutic agent and each dot of the array comprises a different concentration of the therapeutic agent to form a concentration gradient in the y-axis of the array.

14. The system of claim 13, wherein after time point T₁, the array is removed from the fluid medium and the concentration of therapeutic agent remaining on the dots is measured using at least one analytical technique comprising scanning probe microscopy comprising atomic force microscopy, field emission electron microscopy, FTIR microscopy, confocal Raman microscopy, and photoacoustic infrared spectroscopy such that a profile of the release of the therapeutic agent as a function of time, concentration of therapeutic agent, and molar composition of A and B block polymers or random copolymers is produced.

15. The system of claim 13, wherein the array is subjected to subsequent steps of placement in a fluid medium, mechanical testing comprising testing of tack, elastic modulus, elongation modulus, glass transition temperature, nano-indentation, surface topography or at least one analytical technique to obtain additional data at time points Tₓ and T_{final}, wherein x is a whole number greater than 1.

16. An array of simulations of an implantable or insertable medical device having a drug release coating wherein the array is formed of a plurality of dots arranged on a substrate layer having at least an x axis and y axis, each dot comprising a polymeric composition comprising at least one polymer layer comprising a release region wherein a therapeutic agent is within or adjacent to release region, wherein a gradient exists in at least one of the x axis or y axis for at least one pre-selected parameter, and the array is analyzed using at least one analytical technique at least at two time points, T₀ and T₁ to generate data at these time points for the pre-selected parameter.

17. The array of claim 16, wherein the dots comprise a fluid medium comprising polymer melts, dispersions, emulsions, colloids, slurries, suspensions, or supercritical fluids wherein fluid is evaporated resulting in an array of solid dots.

18. The array of claim 16, further comprising at least one barrier layer, wherein substrate layer, barrier layer, and polymer layer are applied sequentially to each dot to create a laminate structure such that each dot comprises a multi-layered structure having a substrate layer, and at least one barrier layer, and at least one polymer layer.

19. The array of claim 18, further comprising at least one additive layer comprising one or more of drug release modifiers, chemical stabilizers, leveling agents, plasticizers, elastomeric additives, whetting agents, slip agents, therapeutic agents, lubricants, cross-linking agents, free radical initiators, free radical scavengers, antioxidants, colorants, radioopacifiers, stiffening agents, nucleating agents, and swelling agents.

20. The array of claim 16, wherein the dots are arranged to form an array using ink-jet printing selected from the group consisting of drop-on-demand printing and continuous mode printing.

21. The array of claim 16, wherein a gradient exists in at least one of the x axis or y axis for at least one pre-selected parameter.

22. The array of claim 20, wherein the array is analyzed using at least one analytical technique at least at two time points, T₀ and T₁ to generate data at these time points for a pre-selected parameter.

23. The array of claim 22, wherein the analytical technique comprises scanning probe microscopy comprising atomic force microscopy, field emission electron microscopy, FTIR microscopy, confocal Raman microscopy, and photoacoustic infrared spectroscopy.

24. The array of claim 16, wherein the release region comprises a copolymer that further comprises (i) a biostable block or (ii) a biodisintegrable polymer block.

25. The array of claim 24, wherein the release region comprises a biostable block copolymer comprising polystyrene-polyisobutylene-polystyrene and the therapeutic agent comprises paclitaxel.

26. The array of claim 16, wherein the substrate comprises stainless steel, titanium, tantalum, gold, platinum, gold-plated stainless steel, cobalt-chromium alloys including but not limited to cobalt-chromium-nickel-molybdenum-iron alloys, shape-memory alloys comprising nickel-titanium (Ni—Ti), Ni—Ti-based alloys, polymer-covered Ni—Ti comprising polytetrafluoroethylenes (PTFE)-covered Ni—Ti, carbon-fiber composites, polymers comprising silicone, plastics comprising polyethylenes or polyurethanes, ceramics, natural polymers comprising biologically-occurring polymers comprising Type I collagen, and biodisintegrable polymers comprising polyesters, polyorthoesters, and polyanhydrides further comprising poly(ether-ester)s, L,L-dilactide, diglycolid, and p-dioxanone.

27. The array of claim 22, wherein the data for at least two of the array dots is analyzed with data-mining software.

28. The array of claim 16, wherein the data for at least two of the array dots is analyzed using a computational algorithm comprising MonteCarlo algorithm, Bayesian Inference computation, and dynamic Monte Carlo using Markov Chains.

29. The array of claim 16, wherein the polymer composition comprises a biostable polymer, wherein the array is placed in a fluid medium and the concentration of therapeutic agent at time T₁ is measured using non-destructive methods comprising Raman or infrared spectroscopy, wherein spectroscopy peaks are measured against a standard to quantify release of therapeutic agent from the polymer composition.

30. The array of claim 16, wherein the polymer composition comprises a biodisintegrable polymer, wherein the array is subjected to a fluid medium and the concentration of therapeutic agent at time T₁ is measured using non-destructive methods comprising Raman or infrared spectroscopy, wherein the release of therapeutic agent from the polymer is quantified by correlating an increase in signal attenuation to disintegration of the polymer.

31. The array of claim 21, wherein the polymer composition comprises a diblock copolymer having constituent blocks A and B, wherein the array is subjected to a fluid medium and the pre-selected parameter comprises molar composition of A and B and each dot of the array comprises a different composition of constituents A and B to form a molar gradient in the x-axis of the array.

32. The array of claim 31, wherein a second pre-selected parameter comprises the concentration of therapeutic agent and each dot of the array comprises a different concentration of the therapeutic agent to form a concentration gradient in the y-axis of the array.

33. The array of claim 30, wherein after time point T₁, the array is removed from the fluid medium and the concentration of therapeutic agent remaining on the dots is measured using at least one analytical technique comprising scanning probe microscopy comprising atomic force microscopy, field emission electron microscopy, FTIR microscopy, confocal Raman microscopy, and photoacoustic infrared spectroscopy such that a profile of the release of the therapeutic agent as a function of time, concentration of therapeutic agent, and molar composition of A and B block polymers is produced.

34. The array of claim 33, wherein the array is subjected to subsequent steps of placement in a fluid medium, mechanical testing comprising testing of tack, elastic modulus, elongation modulus, glass transition temperature, nano-indentation, surface topography or at least one analytical technique to obtain additional data at time points Tₓ and T_{final}, wherein x is a whole number greater than 1.

35. A method for high-throughout analysis of a coating composition for implantable and insertable medical devices comprising: forming an array of a plurality of dots comprising a polymeric composition by ink-jet deposition on a substrate having at least an x axis and y axis, varying at least one compositional or mechanical characteristic for the polymeric composition from dot to dot such that a gradient exists in at least one of the x axis or y axis for the characteristic, and analyzing the array using at least one analytical technique at least at two time points, T₀ and T₁ to generate data at these time points for the characteristic.
